(19) United States
(12) Patent Application Publication
(10) Pub. No.: US 2015/0378483 A1
(43) Pub. Date: Dec. 31, 2015

(54) METHOD FOR PRODUCING PRESSURE DETECTION DEVICE, PRESSURE DETECTION DEVICE, PRESSURE-SENSITIVE SENSOR, AND ELECTRONIC DEVICE

(71) Applicant: FUJIKURA LTD., Kohtoh-ku, Tokyo (JP)

(72) Inventors: Yasuyuki TACHIKAWA, Sakura-shi (JP); Toshimizu TOMITSUKA, Sakura-shi (JP); Makoto TAKAMATSU, Sakura-shi (JP); Osamu AOKI, Sakura-shi (JP); Toshiaki WATANABE, Sakura-shi (JP)

(73) Assignee: FUJIKURA LTD., Kohtoh-ku, Tokyo (JP)

(21) Appl. No.: 14/765,506

(22) PCT Filed: Jan. 30, 2014
(86) PCT No.: PCT/JP2014/052078

§ 371 Date: Aug. 3, 2015

(30) Foreign Application Priority Data
Feb. 6, 2013 (JP) 2013-021077
Aug. 9, 2013 (JP) 2013-166201

(51) Int. Cl. G06F 3/047; G06F 3/045; G06F 3/041; G01L 1/22

(52) U.S. Cl. CPC G06F 3/047; G01L 1/225; G06F 3/045; G06F 3/0414; G06F 2203/04103

(57) ABSTRACT

A method for producing a pressure detection device (1) includes a first process (S10) of preparing a pressure-sensitive sensor (2) which includes a first circuit (91) and a second circuit (92) electrically connecting each other in series, the first circuit (91) including a pressure-sensitive body (4) of which an electrical resistance value is consecutively changed according to a pressure, the second circuit (92) including a fixed resistor (5) of which an electrical resistance value can be adjusted to be a desired value; and a second process (S20) of adjusting the electrical resistance value of the fixed resistor (5) on the basis of a ratio (R₂:R₁) between an electrical resistance value (R₂) of at least pressure-sensitive body (4) in the first circuit (91) and an electrical resistance value (R₁) of at least fixed resistor (5) in the second circuit (92) in a case where a predetermined pressure is applied to the pressure-sensitive body (4).

### TECHNICAL FIELD

The present invention relates to a method for producing a pressure detection device including a pressure-sensitive sensor of which an electrical resistance value is consecutively changed according to a pressure, a pressure detection device, a pressure-sensitive sensor which can be used in the pressure detection device, and an electronic device which includes the pressure-sensitive sensor.

For the designated countries which permit the incorporation by reference, the contents described and/or illustrated in Japanese Patent Application No. 2013-21077 filed on Feb. 6, 2013 and Japanese Patent Application No. 2013-166201 filed on Aug. 9, 2013 are incorporated by reference in the present application as a part of the description and/or drawings of the present application.

### BACKGROUND ART

There is disclosed a pressure-sensitive sensor which calculates an external force on the basis of standard information S_{(FX)} of an external force-resistance characteristic in order to reduce a deviation between products when the external force is measured (see Patent Document 1).

An approximation formula indicating an output-to-pressure relation is obtained on the basis of measured data for each of pressure-sensitive elements provided in the pressure-sensitive sensor in order to perform calibration, so that a measurement accuracy of the pressure-sensitive sensor is improved (see Patent Document 2).

### CITATION LIST

### Patent Document

Patent Document 1: JP 2011-133421 A

Patent Document 2: JP 2005-106513 A

### DISCLOSURE OF THE INVENTION

### Problem to be Solved by the Invention

In the invention described above, the data obtained by the measurement is corrected through a computer process. Therefore, there is a problem in that when a measurement amount of the pressure-sensitive sensor is increased, the processing performance of the computer is excessively loaded, so that a response of the pressure-sensitive sensor is delayed.

An object to be achieved in the invention is to provide a method for producing a pressure detection device which can reduce a measurement deviation and suppress a response delay in a case where the measurement amount is increased, a pressure detection device, a pressure-sensitive sensor which can be used in the pressure detection device, and an electrode device which includes the pressure-sensitive sensor.

### Means for Solving Problem

A method for producing a pressure detection device according to the invention includes: a first process of preparing a pressure-sensitive sensor which includes a first circuit and a second circuit electrically connecting each other in series, the first circuit including a pressure-sensitive body of which an electrical resistance value is consecutively changed according to a pressure, the second circuit including a fixed resistor of which an electrical resistance value can be adjusted to be a desired value; and a second process of adjusting the electrical resistance value of the fixed resistor on the basis of a ratio between an electrical resistance value of at least pressure-sensitive body in the first circuit and an electrical resistance value of at least fixed resistor in the second circuit in a case where a predetermined pressure is applied to the pressure-sensitive body.

A method for producing a pressure detection device according to the invention includes: a first process of preparing a pressure-sensitive sensor which includes a first circuit and a second circuit electrically connecting each other in series, the first circuit including a pressure-sensitive body of which an electrical resistance value is consecutively changed according to a pressure, the second circuit including a fixed resistor of which an electrical resistance value can be adjusted to be a desired value; and a second process of adjusting the electrical resistance value of the fixed resistor on the basis of a partial voltage of at least the pressure-sensitive body in the first circuit or a partial voltage of at least the fixed resistor in the second circuit in a case where a predetermined pressure is applied to the pressure-sensitive body and a predetermined voltage is applied to the pressure-sensitive sensor.

In the invention described above, the second process may include adjusting a volume of the fixed resistor so as to adjust the electrical resistance value of the fixed resistor.

In the invention described above, the first process may include measuring at least one of the partial voltage of at least the pressure-sensitive body in the first circuit and the partial voltage of at least the fixed resistor in the second circuit, or measuring the electrical resistance value of at least the pressure-sensitive body in the first circuit and the electrical resistance value of at least the fixed resistor in the second circuit.

In the invention described above, the first circuit may include a first resistor which is electrically connected to the pressure-sensitive body in parallel.

In the invention described above, the second circuit may include a second resistor which is electrically connected to the fixed resistor in parallel.

In the invention described above, the pressure-sensitive body may include: a first substrate on which a first electrode is provided; a second substrate having a second electrode provided to face the first electrode; a spacer which is interposed between the first substrate and the second substrate; and a pressure-sensitive material which is provided to cover at least one surface of the first electrode and the second electrode.

A pressure detection device according to the invention includes: a pressure-sensitive sensor which includes a first circuit and a second resistor electrically connecting each other, the first circuit including a pressure-sensitive body of which an electrical resistance value is consecutively changed according to a pressure, the second circuit including a fixed resistor; a voltage applying unit configured to apply a predetermined voltage to the pressure-sensitive sensor; and a measurement unit configured to measure at least one of a partial voltage of at least the pressure-sensitive body in the first circuit and a partial voltage of at least the fixed resistor in the second circuit, or an electrical resistance value of at least the pressure-sensitive body in the first circuit and an electrical resistance value of at least the fixed resistor in the second circuit. The electrical resistance value of the fixed resistor is capable of being adjusted to adjust a ratio between the electrical resistance value of at least the pressure-sensitive body in the first circuit and the electrical resistance value of at least the fixed resistor in the second circuit in a case where a predetermined pressure is applied to the pressure-sensitive body.

In the invention described above, the electrical resistance value of the fixed resistor may be capable of being adjusted by partially removing the fixed resistor.

A pressure-sensitive sensor according to the invention includes: a pressure-sensitive body configured to have an electrical resistance value which is consecutively changed according to a pressure; and a fixed resistor configured to be capable of being partially removed. The pressure-sensitive body includes: a first substrate which has a first electrode and a first connection pattern extending from the first electrode; a second substrate which has a second electrode provided to face the first electrode and a second connection pattern extending from the second electrode; a spacer which is interposed between the first substrate and the second substrate; and a pressure-sensitive material which is provided to cover at least one surface of the first electrode and the second electrode. The first substrate has: a first connection piece which is branched from the first connection pattern and electrically connected to one end of the fixed resistor; a second connection piece which is electrically connected to the other end of the fixed resistor; and a third connection pattern which is provided in the second connection piece. The fixed resistor is interposed between the first connection piece and the second connection piece.

In the invention described above, the first substrate and the second substrate may be the same substrate which is bent at a bending portion. The first substrate further may have a fourth connection pattern which is electrically connected to the second connection pattern through the bending portion.

An electronic device according to the invention includes: a panel unit; and pressure-sensitive sensors configured to be deformed according to a pressure through the panel unit. Each of the pressure-sensitive sensors includes a first circuit and a second circuit which electrically contacting each other in series, the first circuit including at least pressure-sensitive body of which an electrical resistance value is consecutively changed according to a pressure, the second circuit including at least fixed resistor. Resistance ratios of the pressure-sensitive sensors are substantially equal to each other. The resistance ratio is a ratio between an electrical resistance value of at least the pressure-sensitive body in the first circuit in a case where a predetermined pressure is applied to the pressure-sensitive body and an electrical resistance value of at least the fixed resistor in the second circuit in a case where the predetermined pressure is applied to the pressure-sensitive body.

### Effect of the Invention

According to the invention, a volume of a fixed resistor which is electrically connected to a pressure-sensitive body in series is adjusted on the basis of a ratio between an electrical resistance of at least the pressure-sensitive body in a first circuit and an electrical resistance value of at least the fixed resistor in a second circuit in a case where a predetermined pressure is applied to the pressure-sensitive body, so that a partial voltage of the fixed resistor or a partial voltage of the pressure-sensitive body can be optimized. Therefore, there is no need to perform a computer process to correct a measurement error at the time of detecting a pressure. The measurement deviation among products of the pressure detection device or among the pressure-sensitive sensors of an electronic device can be reduced. Further, a response delay at the time of the measurement can be suppressed.

### BRIEF DESCRIPTION OF DRAWINGS

FIG. 1 is a conceptual diagram illustrating the entire pressure detection device in a first embodiment of the invention;

FIGS. 2(A) and 2(B) are diagrams illustrating a pressure-sensitive sensor in the embodiment, in which FIG. 2(A) is an exploded perspective view and FIG. 2(B) is a plan view;

FIG. 3 is a cross-sectional view taken along line III-III of FIG. 2(B);

FIG. 4 is an enlarged view illustrating portion IV of FIG. 2(B);

FIG. 5 is a process chart illustrating a method for producing the pressure detection device in the first embodiment of the invention;

FIGS. 6(A) and 6(B) are graphs illustrating a relation between a load applied to the pressure detection device and a partial voltage of a fixed resistor in the first embodiment of the invention, in which FIG. 6(A) is a graph illustrating a state before a volume of the fixed resistor is adjusted and FIG. 6(B) is a graph illustrating a state after the volume of the fixed resistor is adjusted;

FIG. 7 is an electric circuit diagram illustrating the pressure detection device in the first embodiment of the invention;

FIG. 8 is a conceptual diagram illustrating the entire pressure detection device in a second embodiment of the invention;

FIG. 9 is an electric circuit diagram illustrating a pressure detection device in a third embodiment of the invention;

FIG. 10 is an electric circuit diagram illustrating a pressure detection device in a fourth embodiment of the invention;

FIG. 11 is a plan view illustrating an electronic device in a fifth embodiment of the invention;

FIG. 12 is a cross-sectional view taken along line XII-XII of FIG. 11;

FIG. 13 is an exploded perspective view of a touch panel in the fifth embodiment of the invention;

FIG. 14 is a cross-sectional view illustrating a pressure-sensitive sensor and an elastic member in the fifth embodiment of the invention;

FIG. 15 is a plan view of a display device in the fifth embodiment of the invention; and

FIG. 16 is an electric circuit diagram illustrating a pressure detection device in another embodiment of the invention.

### MODE(S) FOR CARRYING OUT THE INVENTION

Hereinafter, embodiments of the invention will be described with reference to the drawings.

### First Embodiment

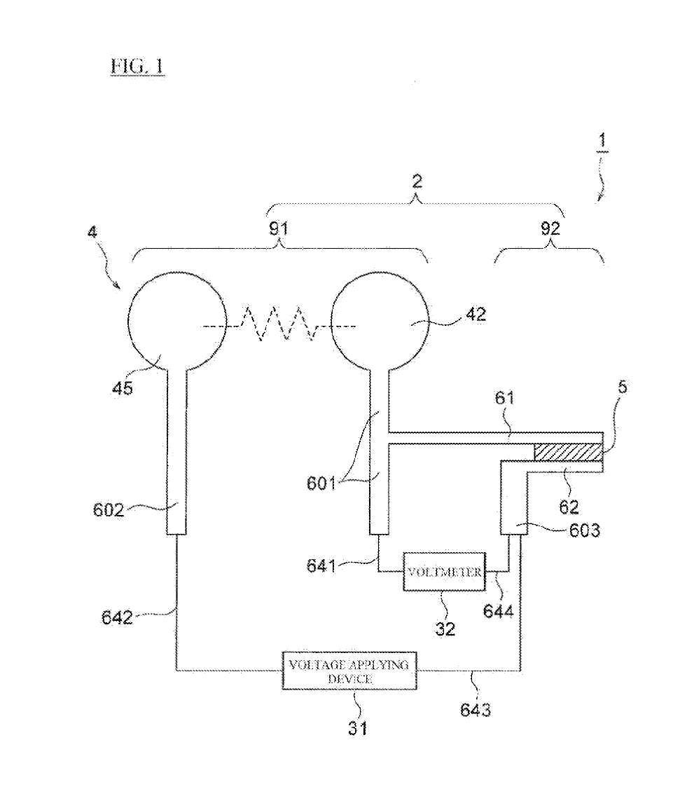

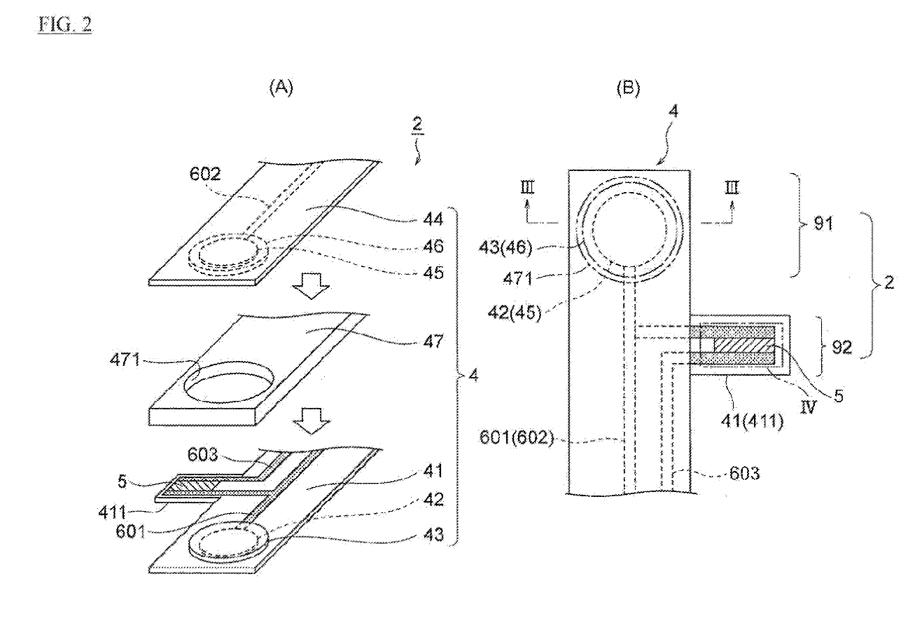

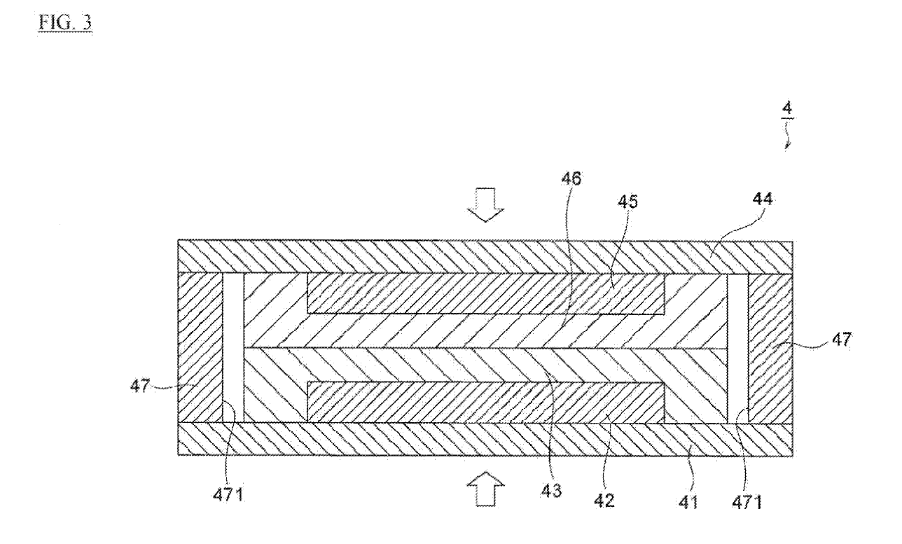

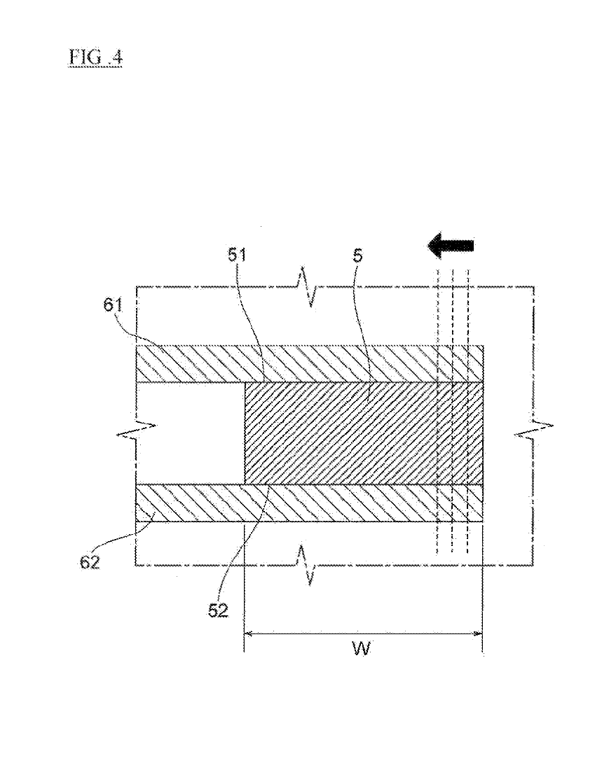

FIG. 1 is a conceptual diagram illustrating the entire pressure detection device 1 in the embodiment, FIGS. 2(A) and 2(B) are an exploded perspective view and a plan view illustrating a pressure-sensitive sensor 2, FIG. 3 is a cross-sectional view taken along line III-III in FIG. 2(B), and FIG. 4 is an enlarged view of portion IV in FIG. 2(B).

As illustrated in FIG. 1, the pressure detection device 1 in the embodiment includes the pressure-sensitive sensor 2, a voltage applying device 31 which applies a predetermined voltage to the pressure-sensitive sensor 2, and a voltmeter 32 which measures a partial voltage V_{P1} of a fixed resistor 5 of the pressure-sensitive sensor 2. In the embodiment, the pressure-sensitive sensor 2 and the voltage applying device 31 are electrically connected in series through first to third wiring patterns 601 to 603 and first to fourth wirings 641 to 644 which are configured by cables.

The pressure-sensitive sensor 2 includes a first circuit 91 and a second circuit 92 electrically connect each other in series. The first circuit 91 includes a pressure-sensitive body 4 which is a portion to detect a pressure, and the second circuit 92 includes the fixed resistor 5 which adjusts a partial voltage applied to the pressure-sensitive body 4.

As illustrated in FIG. 2(A), the pressure-sensitive body 4 includes a first substrate 41 and a second substrate 44 which is provided in substantial parallel with the first substrate 41. A first electrode 42 and a first pressure-sensitive material 43 are provided on the upper surface of the first substrate 41 in FIG. 2(A), and a second electrode 45 and a second pressure-sensitive material 46 are provided on the lower surface of the second substrate 44 in FIG. 2. A spacer 47 is provided between the first and second substrates 41 and 44.

The first substrate 41 and the second substrate 44 have substantially the same-sized rectangular shape, and are formed of a flexible insulative film. As a material for such an insulative film, polyethylene-telephthalate (PET), polyethylene naphthalate (PEN), polyimide resin (PI), and polyetherimide resin (PEI) may be exemplified. As illustrated in FIGS. 2(A) and 2(B), a projection portion 411 is provided at the side portion of the first substrate 41 in a longitudinal direction, and the fixed resistor 5 described below is provided on the projection portion 411.

The first electrode 42 is formed by printing and curing conductive paste such as silver paste, gold paste, and copper paste on the first substrate 41. Similarly, the second electrode 45 is also formed by printing and curing the conductive paste such as the silver paste, the gold paste, and the copper paste on the second substrate 44. The first electrode 42 may be configured by a highly-resistive conduction material such as carbon. Similarly, the second electrode 45 may be configured by the highly-resistive conduction material such as carbon.

As a specific printing method for forming the first electrode 42 and the second electrode 45, a screen printing method, a gravure offset printing method, and an inkjet printing method can be exemplified. In the embodiment, the first and second electrodes 42 and 45 are formed in a circular shape, but the shapes of the first and second electrodes 42 and 45 are not particularly limited.

As illustrated in FIG. 2(A), the first electrode 42 is electrically connected to the first wiring pattern 601. The first wiring pattern 601 is formed by printing and curing the conductive paste such as the silver paste, the gold paste, and the copper paste on the first substrate 41. The third wiring pattern 603 described below is also formed by printing and curing the conductive paste such as the silver paste, the gold paste, and the copper paste on the first substrate 41.

On the other hand, the second electrode 45 is electrically connected to the second wiring pattern 602. The second wiring pattern 602 is formed by printing and curing the conductive paste such as the silver paste, the gold paste, and the copper paste on the second substrate 42.

As a specific printing method for forming the wiring patterns 601 to 603, the screen printing method, the gravure offset printing method, and the inkjet printing method can be exemplified.

The first pressure-sensitive material 43 and the second pressure-sensitive material 46, for example, are configured by the highly-resistive conduction material such as carbon. Specifically, the first pressure-sensitive material 43 and the second pressure-sensitive material 46 are formed by printing and curing carbon paste to cover the first and second electrodes 42 and 45.

In a case where the first electrode 42 is configured by the highly- resistive conduction material such as carbon, the first electrode 42 and the first pressure-sensitive material 43 may be integrally formed. Similarly, in a case where the second electrode 45 is configured by the highly-resistive conduction material such as carbon, the second electrode 45 and the second pressure-sensitive material 46 may be integrally formed.

Instead of such a highly-resistive conduction material, the pressure-sensitive materials 43 and 46 may be configured by the material of which the electrical resistance value is changed according a load (the pressure) applied onto the pressure-sensitive materials 43 and 46. As such a material, there can be exemplified a conductive rubber obtained by mixing carbon powder or metal powder such as silver, gold, and germanium into a rubber composition. The pressure-sensitive materials 43 and 46 may be configured using a material in which semiconductor particles such as molybdenum disulfide particles are contained.

As the pressure-sensitive materials 43 and 46, a material may be used in which a tunneling current flows according to a pressure applied from the outside. As such material, an available quantum tunneling composite (a trade name “QTC” made by PERATECH LTD) can be exemplified.

Unevenness may be formed in the surface of the pressure-sensitive materials 43 and 46 by containing beads in the pressure-sensitive materials 43 and 46. In this case, a change of an electrical resistance value of the pressure-sensitive body 4 becomes gentle with respect to a pressure applied to the pressure-sensitive body 4, and a detection accuracy of the pressure detection device 1 is improved. Such beads are desirably configured by an organic elastic filler or an inorganic oxide filler m. As the organic elastic filler, a silicon-based, acrylic-based, styrene-based, or urethane-based polymer, or nylon 6, nylon 11, or nylon 12 may be used. The beads are desirably to be added by a volume ratio of 10% to 30% with respect to the pressure-sensitive materials 43 and 46. In this case, the detection accuracy of the pressure detection device 1 is more improved.

As illustrated in FIG. 3, the first pressure-sensitive material 43 is formed to cover the upper side surface of the first electrode 42 in the drawing. On the other hand, the second pressure-sensitive material 46 is formed to cover the lower side surface of the second electrode 45 in the drawing. Only one of the first pressure-sensitive material 43 or the second pressure-sensitive material 46 may be provided. In a case where the above-mentioned conductive rubber, a semiconductor material, or a quantum tunneling composite is used as the first and second pressure-sensitive materials 43 and 46, the pressure-sensitive materials 43 and 46 may be integrally formed as a single member.

The shapes of the first and second electrodes and the first and second pressure-sensitive materials are not particularly limited. For example, one or both of the first and second electrodes may be formed in a ring shape. One or both of the first and second pressure-sensitive materials may be formed in a ring shape.

The configuration of the pressure-sensitive body is not particularly limited. For example, one of the first electrode and the second electrode may be divided into two electrodes independent of each other, and one of the divided electrodes may be connected to the first wiring pattern, and the other one may be connected to the second wiring pattern. In this case, each of the divided two electrodes may be formed in a comb-tooth shape, and the two electrodes may be disposed such that these comb-tooth shape portions are separated from and face each other.

The spacer 47 in the embodiment is a member which is interposed between the first substrate 41 and the second substrate 44 so as to keep a certain distance between the first and second substrates 41 and 44. As illustrated in FIGS. 2(A) and 2(B), the spacer 47 has a rectangular shape substantially equal to the first and second substrates 41 and 44, and is formed of an insulative material such as polyethylene-telephthalate (PET), polyethylene naphthalate (PEN), polyetherimide resin (PI), or polyetherimide resin (PEI).

As illustrated in FIGS. 2(A) and 2(B), an opening 471 is provided at a substantially center of the spacer 47, and the opening 471 has an outer diameter slightly larger than that of the first and second pressure-sensitive materials 43 and 46. As illustrated in FIG. 3, the thickness of the spacer 47 is substantially equal to a thickness obtained by adding the thickness of the first and second electrodes 42 and 45 and the thickness of the pressure-sensitive materials 43 and 46 formed between the electrodes 42 and 45. Therefore, the opening 471 of the spacer 47 holds the electrodes 42 and 45 and the pressure-sensitive materials 43 and 46, and the pressure-sensitive materials 43 and 46 are disposed in a state where the both are approached or connected to each other. If the pressure-sensitive materials 43 and 46 are placed in contact with each other in a no-load state, there is no space between the electrodes until the current flows by an applied pressure, so that it is possible to improve the detection accuracy in the pressure-sensitive sensor 2.

The configuration of the pressure-sensitive body 4 may be inverted in the vertical direction. That is, in FIG. 2(A), the first substrate 41, and the first electrode 42 and the first pressure-sensitive material 43 provided on the first substrate 41 may be disposed on the upper side in the drawing, and the second substrate 44, and the second electrode 45 and the second pressure-sensitive material 46 provided on the second substrate 44 may be disposed on the lower side in the drawing.

Next, the fixed resistor 5 will be described. In the embodiment, as described below, the description will be made such that the electrical resistance value is adjusted by performing a trimming, but any method may be employed as long as the electrical resistance value of the fixed resistor 5 can be finely adjusted. Therefore, the invention includes a case where the fixed resistor 5 is formed as a variable resistor (volume).

As illustrated in FIG. 2(B), the fixed resistor 5 in the embodiment has a rectangular shape, and is disposed between first and second connection pieces 61 and 62 to be described below. The fixed resistor 5 is configured by a member having an electrical resistance value relatively higher than those of the first and second connection pieces 61 and 62. As such a member, carbon may be exemplified.

The fixed resistor 5 in the embodiment is formed by printing and curing carbon paste on the projection portion 411 of the first substrate 41. As a specific printing method for forming the fixed resistor 5, the screen printing method, the gravure offset printing method, or the inkjet printing method may be exemplified.

As illustrated in FIG. 4, the first connection piece 61 extending along the first side portion 51 is provided on a side near a first side portion 51 of the fixed resistor 5. On the other hand, the second connection piece 62 extending along the second side portion 52 is provided on a side near a second side portion 52 of the fixed resistor 5. The first side portion 51 in the embodiment corresponds to an example of one end of the fixed resistor in the invention, and the second side portion 52 in the embodiment corresponds to an example of the other end of the fixed resistor in the invention.

The first connection piece 61 is a wiring which is formed by printing and curing the conductive paste such as the silver paste, the gold paste, or the copper paste on the first substrate 41, and is formed to be branched from the above-mentioned first wiring pattern 601. The first connection piece 61 is electrically connected to the fixed resistor 5 at the first side portion 51.

The second connection piece 62 is also a wiring which is formed by printing and curing the conductive paste such as the silver paste, the gold paste, or the copper paste on the first substrate 41, and as illustrated in FIG. 1, is electrically connected to the third wiring pattern 603. As illustrated in FIG. 4, the second connection piece 62 is electrically connected to the fixed resistor 5 at the second side portion 52. The shapes of the first and second connection pieces 61 and 62 are not particularly limited.

As a specific printing method for forming the first and second connection pieces 61 and 62, the screen printing method, the gravure offset printing method, and the inkjet printing method can be exemplified.

In the embodiment, the first and second connection pieces 61 and 62, the first electrode 42, and the wiring patterns 601 and 603 are formed by being simultaneously printed on the first substrate 41, but these may be formed by being separately printed and cured. The second electrode 45 and the wiring pattern 602 are also formed by being simultaneously printed on the second substrate 42, but these may be formed by being separately printed and cured.

As illustrated in FIG. 1, the first wiring pattern 601 is connected to one terminal of the voltmeter 32 through the first wiring 641. The second wiring pattern 602 is connected to one terminal of the voltage applying device 31 through the second wiring 642. The third wiring pattern 603 is connected to the other terminal of the voltage applying device 31 through the third wiring 643, and also connected to the other terminal of the voltmeter 32 through the fourth wiring 644.

Therefore, as illustrated in FIG. 1, the first connection piece 61 is electrically connected to the voltmeter 32 and the first electrode 42 of the pressure-sensitive body 4. The second connection piece 62 is electrically connected to the voltmeter 32 and the voltage applying device 31.

The first wiring pattern 601 and the first wiring 641 in the embodiment correspond to an example of a first connection portion in the invention, the second wiring pattern 602 and the second wiring 642 in the embodiment correspond to an example of a second connection portion in the invention, and the third wiring pattern 603, the third wiring 643, and the fourth wiring 644 in the embodiment correspond to an example of a third connection portion in the invention.

The voltage applying device 31 is configured by a direct-current power supply, and applies a voltage V_{A} to an electric circuit of the pressure detection device 1. The voltage applying device 31 in the embodiment corresponds to an example of a voltage applying unit of the invention.

In the embodiment, as illustrated in FIG. 1, there is provided the voltmeter 32 which measures the partial voltage V_{P1} applied to the fixed resistor 5 as the voltage is applied by the voltage applying device 31. The voltmeter 32 in the embodiment corresponds to an example of a partial voltage measuring unit of the invention.

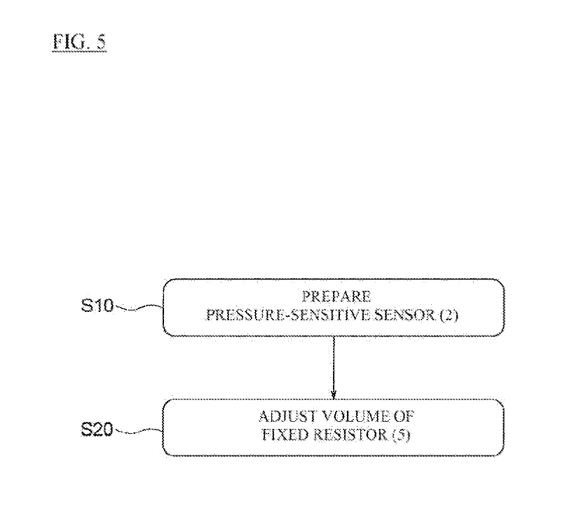

Next, a method for producing the pressure detection device 1 in the embodiment will be described. FIG. 5 is a process chart illustrating a method for producing the pressure detection device 1 in the embodiment.

First, in Step S10 of FIG. 5, the pressure-sensitive sensor 2 having the above-mentioned configuration is prepared. Next, in a state where the voltage V_{A} is applied to the entire pressure-sensitive sensor 2 by the voltage applying device 31, a predetermined known pressure is applied to the pressure-sensitive body 4 in a direction of arrow in FIG. 3. Then, in this state, the partial voltage V_{P1} (equal to the partial voltage of the second circuit 92 in the embodiment) applied to the fixed resistor 5 is measured by the voltmeter 32.

Next, in Step S20, the fixed resistor 5 is trimmed along a direction of arrow in FIG. 4 so as to make a measured value shown in the pressure detection device 1 become the value of the known pressure.

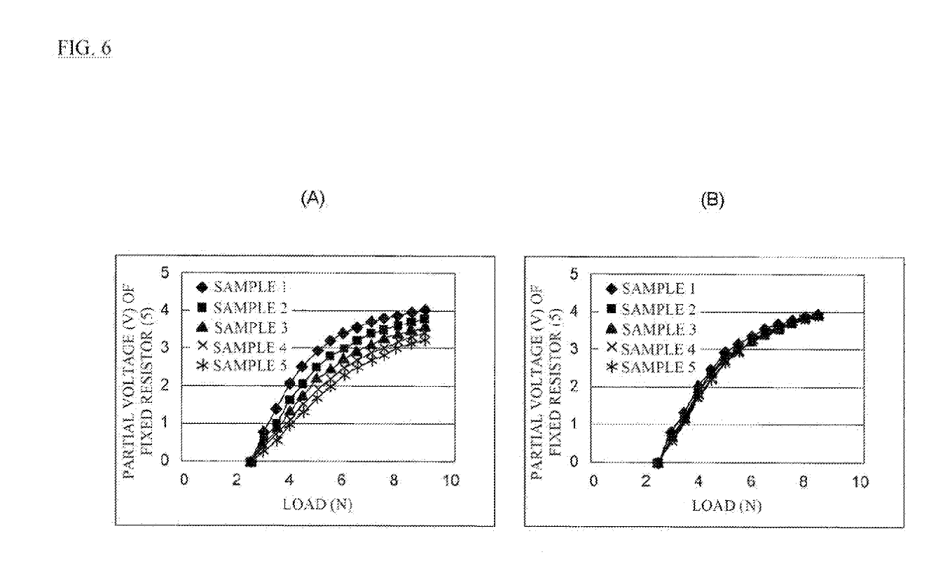

Hereinafter, a specific example when the fixed resistor 5 is trimmed will be described with reference to FIGS. 6(A) and 6(B).

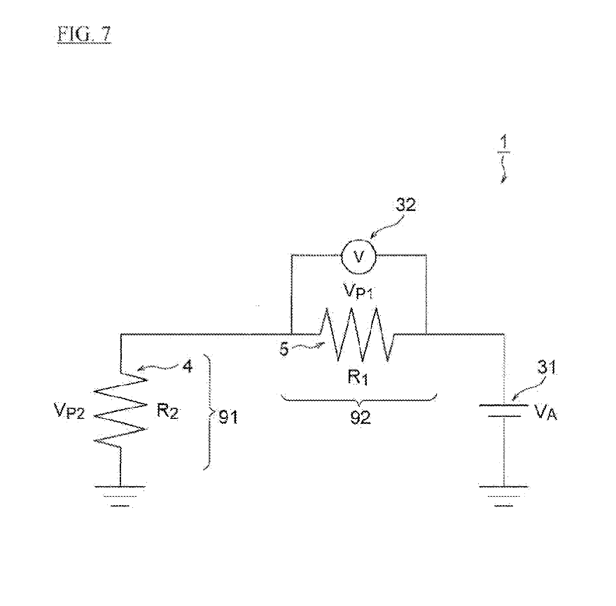

FIGS. 6(A) and 6(B) are graphs illustrating a relation between a load (the pressure) applied to the pressure detection device 1 and the partial voltage V_{P1} of the fixed resistor 5, and the relation is obtained for each sample of the pressure detection device 1 (five samples in this example). FIG. 6(A) is a graph illustrating the relation before the fixed resistor 5 is trimmed, and FIG. 6(B) is a graph illustrating a relation after the fixed resistor 5 is trimmed. FIG. 7 is an electric circuit diagram of the pressure detection device 1.

The thicknesses of the pressure-sensitive materials 43 and 46 are different among samples 1 to 5 before the fixed resistor 5 is trimmed, so that an electrical resistance value R₂ of the pressure-sensitive body 4 is different for the respective samples, and an electrical resistance value R₁ of the fixed resistor 5 also is different for the respective samples. In other words, a ratio (R₂:R₁) between the electrical resistance value R₂ of the pressure-sensitive body 4 and the electrical resistance value R₁ of the fixed resistor 5 is different among the samples. In this case, as illustrated in FIG. 7, the pressure detection device 1 includes a series circuit in the embodiment, so that the ratio (R₂:R₁) is equal to a ratio (V_{P2}:V_{P1}) between a voltage V_{P2} applied to the pressure-sensitive body 4 and the partial voltage V_{P1} applied to the fixed resistor 5 under Ohm's law. Therefore, as illustrated in FIG. 6(A), the partial voltage V_{P1} of the fixed resistor 5 is deviated among the samples 1 to 5. In the embodiment, the voltage V_{A} applied by the voltage applying device 31 is 5 voltage.

Herein, for example, in a case where the partial voltage V_{P1} of the fixed resistor 5 at the time of applying a load of 9N to each pressure-sensitive body 4 (the samples 2 to 5) is matched to 4 voltage in the sample 1 (the ratio (R₂:R₁) between the electrical resistance value R₂ of the pressure-sensitive body 4 and the electrical resistance value R₁ of the fixed resistor 5 is 1:4), the trimming of the fixed resistor 5 is performed as described below.

That is, in a state where the load of 9N is applied to the pressure-sensitive body 4, the fixed resistor 5 is gradually trimmed. At this time, as the cross section of the object becomes smaller, the electrical resistance value of an object becomes larger in inverse proportion to the subject area, so that the electrical resistance value R₁ of the fixed resistor 5 is increased as the trimming is progressed, and the partial voltage V_{P1} of the fixed resistor 5 is also increased under Ohm's law. In this case, the voltage V_{A} applied to the pressure-sensitive sensor 2 is a constant value (5 voltage), and the voltage V_{P2} applied to the pressure-sensitive body 4 becomes (5−V_{P1}) voltage, so that the ratio V_{P2}:V_{P1} becomes the ratio 1:4 when the trimming is progressed until the partial voltage V_{P1} of the fixed resistor 5 becomes 4 voltage. The ratio (R₂:R₁) between the electrical resistance value R₂ of the pressure-sensitive body 4 and the electrical resistance value R₁ of the fixed resistor 5 also becomes 1:4.

The method for trimming the fixed resistor 5 is not particularly limited. For example, the trimming may be performed through a cutting process or a laser process, or the trimming may be performed by bending a prepared vulnerable portion of the fixed resistor 5 to cut the fixed resistor 5. When the fixed resistor 5 is trimmed, the first and second connection pieces 61 and 62 may be simultaneously trimmed, or only the fixed resistor 5 may be trimmed. The projection portion 411 of the first substrate 41 may be simultaneously trimmed.

In the embodiment, the fixed resistor 5 each is trimmed for each sample such that the ratio (R₂:R₁) becomes a predetermined ratio (the ratio 1:4 of the sample 1 in this example) on the basis of the ratio (R₂:R₁) between the electrical resistance value R₂ of the pressure-sensitive body 4 and the electrical resistance value R₁ of the fixed resistor 5 in a case where a predetermined pressure (9N in this example) is applied to the pressure-sensitive body 4.

In the above example, a trimming volume of the fixed resistor 5 is calculated for each of the samples 2 to 5, and the fixed resistor 5 may be trimmed at a time on the basis of the calculated result. In other words, for example, in a case where the sample 3 in FIG. 6(A) is trimmed, the partial voltage V_{P1} of the fixed resistor 5 is 3.5 voltage, so that the ratio between the voltage V_{P2} of the pressure-sensitive body 4 and the partial voltage V_{P1} of the fixed resistor 5 is 1.5:3.5. At this time, the ratio (R₂:R₁) between the electrical resistance value R₂ of the pressure-sensitive body 4 and the electrical resistance value R₁ of the fixed resistor 5 also is 1.5:3.5. Herein, since the electrical resistance value R₂ of the pressure-sensitive body 4 is constant, if the electrical resistance value R₁ of the fixed resistor 5 is 6/3.5 times, the ratio becomes the ratio 1:4 in the sample 1. As the cross section of the object becomes smaller, the electrical resistance value of the object becomes larger in inverse proportion to the subject cross section. Therefore, the fixed resistor 5 may be trimmed at a time at a position where the length W of the fixed resistor 5 illustrated in FIG. 4 becomes 3.5/6 times compared to before the trimming.

While not illustrated in the drawing, instead of the voltmeter 32 which measures the partial voltage V_{P1} of the fixed resistor 5, the voltmeter may be provided to measure a partial voltage V_{P2} of the pressure-sensitive body 4. In this case, the ratio (V_{P2}:V_{P1}) between the partial voltage V_{P2} of the pressure-sensitive body 4 and the partial voltage V_{P1} (=V_{A}−V_{P2}) of the fixed resistor 5 can be obtained from a value of the partial voltage V_{P2} (equal to the partial voltage of the first circuit 91 in the embodiment). Then, the ratio (V_{P2}:V_{P1}) is equal to the ratio (R₂:R₁) between the electrical resistance value R₂ of the pressure-sensitive body and the electrical resistance value R₁ of the fixed resistor 5 under Ohm's law, and the fixed resistor 5 is trimmed through the same method as described above on the basis of the ratio (R₂:R₁). In this case, the partial voltage V_{P2} of the pressure-sensitive body 4 becomes smaller as the fixed resistor 5 is trimmed. Therefore, the trimming of the fixed resistor 5 is ended when the partial voltage V_{P2} of the pressure-sensitive body 4 falls below a predetermined value.

The electrical resistance value R₁ (equal to a combined resistance of the second circuit 92 in the embodiment) of the fixed resistor 5 and the electrical resistance value R₂ (equal to a combined resistance of the first circuit 91 in the embodiment) of the pressure-sensitive body 4 each are measured in advance in Step S10, the ratio (R₂:R₁) between the electrical resistance value R₂ of the pressure-sensitive body 4 and the electrical resistance value R₁ of the fixed resistor 5 may be obtained on the basis of the measured result. In this case, it is assumed that the electrical resistance value R₂ of the pressure-sensitive body 4 is constant, the fixed resistor 5 to be adjusted in the electrical resistance value R₁ may be trimmed such that the ratio (R₂:R₁) becomes a predetermined ratio (the ratio 1:4 of the sample 1 in the above example). As a method for measuring the electrical resistance value R₁ of the fixed resistor 5 and the electrical resistance value R₂ of the pressure-sensitive body 4, a two-terminal method or a four-terminal method may be exemplified.

When the pressure is actually measured using the pressure detection device 1 completely subjected to the above process, the magnitude of the subject pressure is obtained on the basis of the partial voltage V_{P1} (the voltage shown in the voltmeter 32) of the fixed resistor 5 when the subject pressure is applied to the pressure-sensitive body 4. In a case where a voltmeter is provided to measure the partial voltage V_{P2} of the pressure-sensitive body 4 instead of the voltmeter 32, the magnitude of the pressure is obtained on the basis of the partial voltage V_{P2} of the pressure-sensitive body 4.

Step S10 in the embodiment corresponds to an example of a first process in the invention, and Step S20 in the embodiment corresponds to an example of a second process in the invention.

Next, an operation of the embodiment will be described.

As described above, the pressure-sensitive body 4 of the pressure detection device 1 in the embodiment includes two substrates 41 and 44 and the electrodes 42 and 45 and the pressure-sensitive materials 43 and 46 provided between these substrates 41 and 44. In general, the pressure-sensitive sensor mainly configured as described above detects the pressure on the basis of the relation (voltage-load characteristic) between the partial voltage in the pressure-sensitive sensor and the pressure using a phenomenon such that the magnitude of the electrical resistance value of the pressure-sensitive material is changed according to the pressure added to the pressure-sensitive material, and the partial voltage applied to the pressure-sensitive material is also changed.

The voltage-load characteristic is changed by roughness in contact surfaces between the pressure-sensitive materials. Therefore, it is not possible to directly adjust the thickness of these pressure-sensitive materials so as to adjust the partial voltage applied to the pressure-sensitive sensor in each pressure detection device after the pressure-sensitive materials are formed on the electrode. In other words, it is not possible to reduce a deviation of the partial voltage of the pressure-sensitive sensor (consequently, the deviation of the electrical resistance value), which caused from a deviation of the thickness of the pressure-sensitive material among products of the pressure detection devices, by directly adjusting the thickness of the pressure-sensitive material.

On the contrary, as illustrated in FIG. 7, the pressure-sensitive sensor 2 of the pressure detection device 1 in the embodiment includes the fixed resistor 5 electrically connected to the pressure-sensitive body 4 in series, and the pressure (load) applied to the pressure-sensitive body 4 is detected from the partial voltage V_{P1} applied to the fixed resistor 5. In this case, the following Equation (1) is established from Ohm's law.

R₁/R₂=V_{P1}/(V_{A}−V_{P1}) (1)

Therefore, even in a case where the deviation of the electrical resistance value R₂ of the pressure-sensitive body 4 occurs due to the difference in the thicknesses of the pressure-sensitive materials 43 and 46 for each pressure detection device 1, the partial voltage V_{P1} of the fixed resistor 5 (consequently, the ratio (R₂:R₁) between the electrical resistance value R₂ of the pressure-sensitive body 4 and the electrical resistance value R₁ of the fixed resistor 5) can be made to be a unified value among the products only by optimizing the electrical resistance value R₁ of the fixed resistor 5.

In other words, in a case where the partial voltage V_{P1} of the fixed resistor 5 at the time of applying a constant pressure to the pressure-sensitive body 4 is made to be the unified value X for each product of the pressure detection device 1, the electrical resistance value R₁ of the fixed resistor 5 may be adjusted to make the ratio between the electrical resistance value R₁ of the fixed resistor 5 and the electrical resistance value R₂ of the pressure-sensitive body become X: (V_{A}−X) on the basis of the relation of the above Equation (1). That is, the fixed resistor 5 may be trimmed such that the electrical resistance value R₁ of the fixed resistor 5 become X×R₂/(V_{A}−X). Therefore, the partial voltage V_{P1} of the fixed resistor 5 can be made to be the unified value X among the products without directly adjusting the thicknesses (the electrical resistance value R₂ of the pressure-sensitive body 4) of the pressure-sensitive materials 43 and 46 of the pressure-sensitive body 4. Consequently, the ratio (R₂:R₁) between the electrical resistance value R₂ of the pressure-sensitive body 4 and the electrical resistance value R₁ of the fixed resistor 5 can be made to be the unified value among the products. Therefore, it is possible to reduce the measurement deviation among the products of the pressure detection device 1 without changing the voltage-load characteristic of the pressure-sensitive body 4. Even in a case where a variable resistor (volume) is used as the fixed resistor 5, the same effect can be obtained by adjusting the ratio (R₂:R₁) between the electrical resistance value R₂ of the pressure-sensitive body 4 and the electrical resistance value R₁ of the fixed resistor 5 according to the above-mentioned example.

As described above, the pressure detection device 1 in the embodiment can correct the measurement deviation among the products of the pressure detection device 1 without performing a computer process. Therefore, even in a case where the measurement amount of the pressure detection device 1 is increased, it is possible to suppress an occurrence of a response delay caused by the increase of the measurement amount in the pressure detection device 1.

The pressure detection device in which the voltmeter is provided to measure the partial voltage V_{P2} of the pressure-sensitive body 4 instead of the voltmeter 32 which measures the partial voltage V_{P1} of the fixed resistor 5 can also obtain the same effect described above. In other words, through the optimization only by trimming the electrical resistance value R₁ of the fixed resistor 5, the partial voltage V_{P2} of the pressure-sensitive body 4 (consequently, the ratio (R₂:R₁) between the electrical resistance value R₂ of the pressure-sensitive body 4 and the electrical resistance value R₁ of the fixed resistor 5) can be made to be the unified value among the products. Therefore, the measurement deviation among the products of the pressure detection device can be reduced without changing the voltage-load characteristic of the pressure-sensitive body 4, and the occurrence of the response delay in a case where the measurement amount of the pressure detection device is increased can be suppressed.

### Second Embodiment

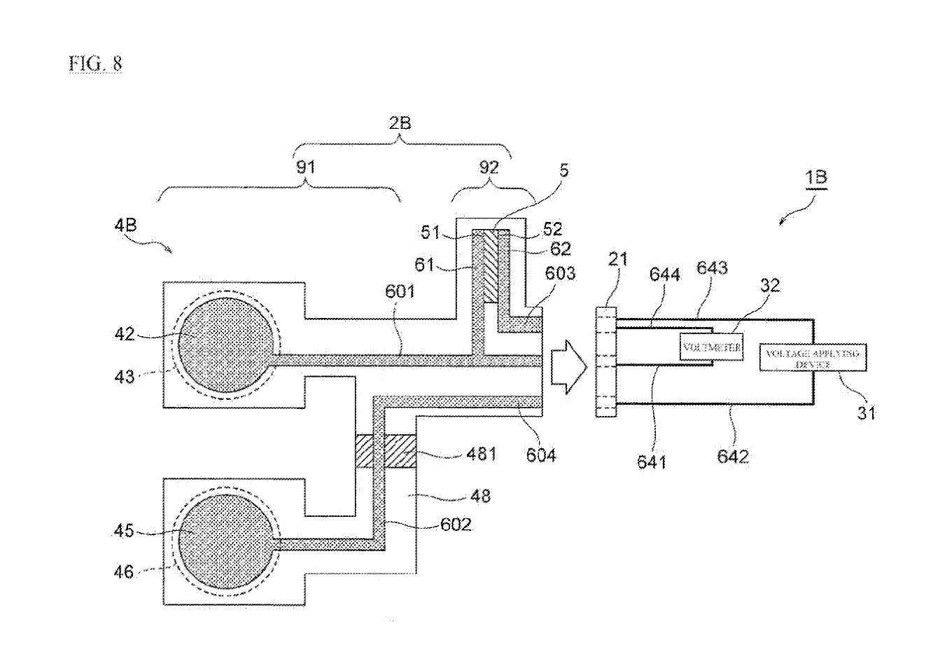

FIG. 8 is a conceptual diagram illustrating the entire pressure detection device 1B in a second embodiment of the invention. Since the pressure detection device 1B in the second embodiment is identical with or similar to that of the above-mentioned first embodiment except that the configuration of a pressure-sensitive sensor 2B and an inner wiring of the pressure detection device 1B are different from that in the first embodiment, the portions different from the first embodiment will be described, and the same portions as those of the first embodiment will be denoted with the same symbols and the description thereof will not be repeated.

As illustrated in FIG. 8, the pressure detection device 1B in the embodiment includes the pressure-sensitive sensor 2B. The pressure-sensitive sensor 2B includes the first circuit 91 and the second circuit 92 electrically connecting each other in series, the first circuit 91 includes a pressure-sensitive body 4B, and the second circuit 92 includes the fixed resistor 5.

The pressure-sensitive body 4B includes the first and second electrodes 42 and 45, the first pressure-sensitive material 43 provided to cover the first electrode 42, and the second pressure-sensitive material 46 provided to cover the second electrode 45, and these components are all provided on the same substrate 48. In the embodiment, the fixed resistor 5 is also provided on the substrate 48.

The substrate 48 is configured by an insulative film having flexibility such as polyethylene-telephthalate (PET), polyethylene naphthalate (PEN), polyetherimide resin (PI), or polyetherimide resin (PEI).

As illustrated in FIG. 8, the first to third wiring patterns 601 to 603 and a fourth wiring 604 are provided on the substrate 48, the first to third wiring patterns 601 to 603 are led toward the right side in the drawing, and a fourth wiring 604 is electrically connected to the second wiring 602 through a bending portion 481 of the substrate 48. The first wiring pattern 601 and the third and fourth wiring patterns 603 and 604 among them are configured to be connected to a connector 21.

In the embodiment, as described above, the first and second electrodes 42 and 45, the first and second pressure-sensitive materials 43 and 46, and the first to fourth wiring pattern 601 to 604 are all provided on the same substrate 48. Then, the substrate 48 is bent at the bending portion 481 which is provided between the first electrode 42 and the second electrode 45 in the substrate 48, so that the first and second electrodes 42 and 45 can be disposed to face each other through the pressure-sensitive materials 43 and 46.

The pressure-sensitive body 4B in the embodiment is configured to interpose a spacer (not illustrated) between the substrate 48 which is bent at the bending portion 481.

As illustrated in FIG. 8, the pressure detection device 1B in the embodiment includes the voltage applying device 31, the voltmeter 32, and the first to fourth wirings 641 to 644 which are formed by cables.

The voltmeter 32 is electrically connected to the first wiring 641 and the fourth wiring 644, and configured to measure a voltage applied between these wirings 641 and 644. On the other hand, the voltage applying device 31 is electrically connected to the second wiring 642 and the third wiring 643.

As illustrated in FIG. 8, the first to fourth wirings 641 to 644 are led toward the left side from the connector 21 in the drawing. The first wiring 641 is electrically connected to the first wiring pattern 601 through the connector 21, and the second wiring 642 is electrically connected to the fourth wiring pattern 604 through the connector 21. The third wiring 643 and the fourth wiring 644 are electrically connected to the third wiring pattern 603 through the connector 21.

The first wiring pattern 601 in the embodiment corresponds to an example of a first connection pattern in the invention, the second wiring pattern 602 in the embodiment corresponds to an example of a second connection pattern in the invention, the third wiring pattern 603 in the embodiment corresponds to an example of a third connection pattern in the invention, and the fourth wiring pattern 604 in the embodiment corresponds to an example of a fourth connection pattern in the invention.

An electric circuit diagram of the pressure detection device 1B in the embodiment is similar to that in FIG. 7 described in the first embodiment. Therefore, in the embodiment, the fixed resistor 5 is trimmed to adjust the ratio (R₂:R₁) between the electrical resistance value R₂ of the pressure-sensitive body 4B and the electrical resistance value R₁ of the fixed resistor 5, so that it is possible to reduce the measurement deviation among the products of the pressure detection device 1B without changing the voltage-load characteristic of the pressure-sensitive body 4B.

In the embodiment, it is possible to correct the measurement deviation among the products of the pressure detection device 1B without performing a computer process. Therefore, even in a case where the measurement amount of the pressure detection device 1B is increased, it is possible to suppress the occurrence of the response delay caused by the increase of the measurement amount.

### Third Embodiment

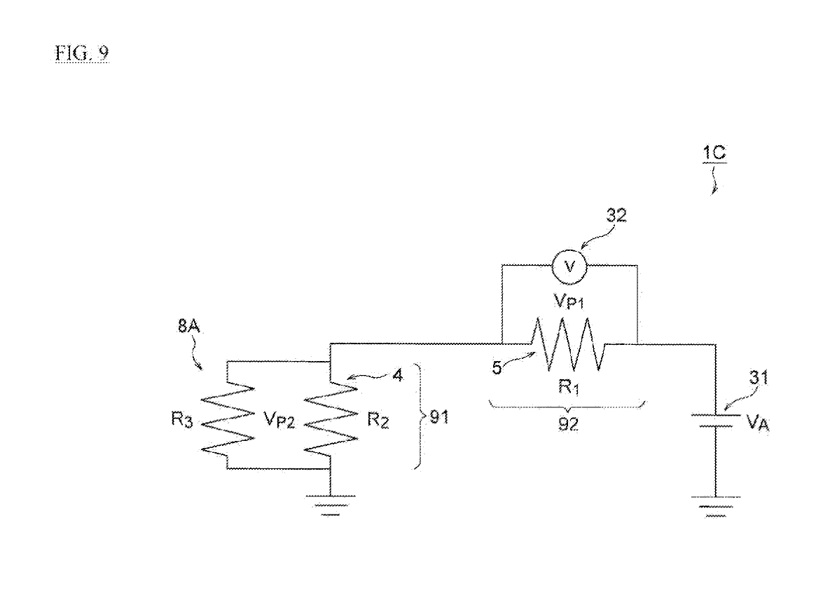

FIG. 9 is an electric circuit diagram illustrating a pressure detection device 1C in a third embodiment of the invention. Since the pressure detection device 1C in the third embodiment is identical with or similar to that in the above-mentioned first embodiment except that the first circuit 91 includes a first resistor 8A, the portions different from the first embodiment will be described, and the same portions as those of the first embodiment will be denoted with the same symbols and the description thereof will not be repeated.

As illustrated in FIG. 9, the first circuit 91 of the pressure detection device 1C in the embodiment includes the first resistor 8A, the first resistor 8A is electrically connected to the pressure-sensitive body 4 in parallel, and the first resistor 8A has a predetermined electrical resistance value R₃. While not illustrated in the drawing, the first resistor 8A, for example, is formed to provide a desired resistance material between the first and second wiring pattern 601 and 602.

The voltage-load characteristic of the pressure detection device is easily deviated in a low load side. In this regard, since a potential difference occurs between both terminals of the pressure-sensitive body 4 by the current flowing to the first resistor 8A even when measuring a minute load, the pressure detection device 1C in the embodiment can absorb the deviation of the low load side in the voltage-load characteristic.

In the pressure detection device 1C of the embodiment, at least one (the partial voltage V_{P1} of the fixed resistor 5 in the embodiment) of the partial voltage V_{P2} of the pressure-sensitive body 4 and the partial voltage V_{P1} of the fixed resistor 5 is measured in a case where a predetermined pressure is applied to the pressure-sensitive body 4 (the first process), and the trimming of the fixed resistor 5 is performed on the basis of the ratio (V_{P2}:V_{P1}) between the partial voltage V_{P2} of the pressure-sensitive body 4 and the partial voltage V_{P1} of the fixed resistor 5 (the second process). Therefore, in the embodiment, it is possible to reduce the measurement deviation among the products of the pressure detection device 1C without changing the voltage-load characteristic of the pressure-sensitive body 4.

Since the first circuit 91 in the embodiment is configured to electrically connect the first resistor 8A and the pressure-sensitive body 4 in parallel, the partial voltage V_{P2} of the pressure-sensitive body 4 is equal to the partial voltage V_{P2′} of the first circuit 91 (V_{P2}=V_{P2′}). Therefore, the partial voltage V_{P2′} of the first circuit 91 is measured (the first process), and the trimming of the fixed resistor 5 may be performed on the basis of the ratio (V_{P2′}:V_{P1}) between the partial voltage V_{P2′} of the first circuit 91 and the partial voltage V_{P1} of the fixed resistor 5 in a case where a predetermined pressure is applied to the pressure-sensitive body 4 (the second process).

In the embodiment, a combined resistance (R₂×R₃/(R₂+R₃)) of the first circuit 91 and the electrical resistance value R₁ of the fixed resistor 5 in a case where a predetermined pressure is applied to the pressure-sensitive body 4 are measured in advance (the first process), and the trimming of the fixed resistor 5 may be performed on the basis of the ratio ((R₂×R₃/(R₂+R₃)):R₁) (the second process).

In the embodiment, it is possible to correct the measurement deviation among the products of the pressure detection device 1C without performing the computer process. Therefore, even in a case where the measurement amount of the pressure detection device 1C is increased, it is possible to suppress the occurrence of the response delay caused by the increase of the measurement amount.

### Fourth Embodiment

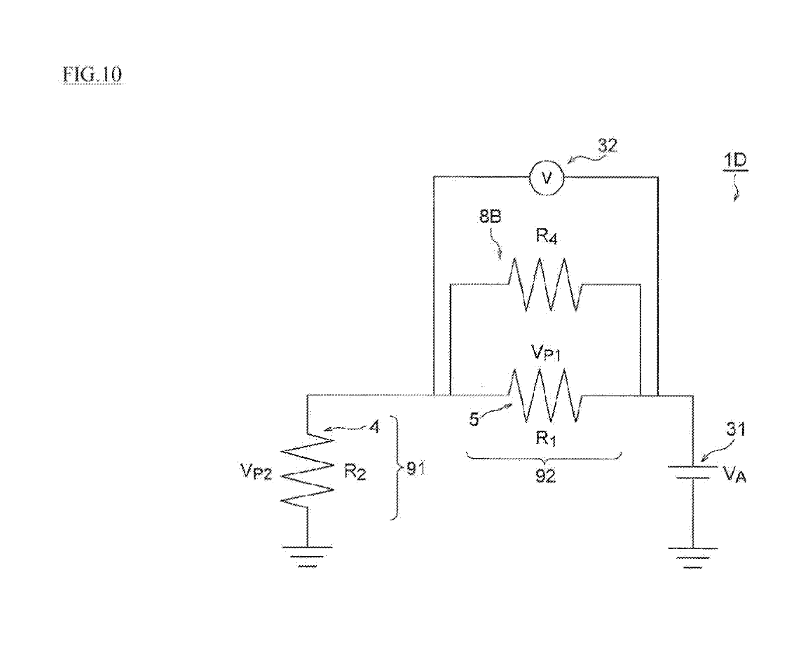

FIG. 10 is an electric circuit diagram illustrating a pressure detection device 1D in a fourth embodiment of the invention. Since the pressure detection device 1D in the fourth embodiment is identical with or similar to the above-mentioned first embodiment except that the second circuit 92 includes a second resistor 8B, the portions different from the first embodiment will be described, and the same portions as those in the first embodiment will be denoted with the same symbols and the description thereof will not be repeated.

As illustrated in FIG. 10, the second circuit 92 of the pressure detection device 1D in the embodiment includes the second resistor 8B, the second resistor 8B is electrically connected to the fixed resistor 5 in parallel, and the second resistor 8B has a predetermined electrical resistance value R₄. While not illustrated in the drawing, the second resistor 8B, for example, is formed by printing and curing a conduction material such as the conductive paste between the first and second connection pieces 61 and 62 on the first substrate 41 with a desired line width.

In the pressure detection device 1D of the embodiment, it is possible to improve the accuracy at the time of trimming the fixed resistor 5 by electrically connecting the second resistor 8B and the fixed resistor 5 in parallel.

For example, the electrical resistance value R₁ of the fixed resistor 5, the electrical resistance value R₂ of the pressure-sensitive body 4 under a predetermined load, and the electrical resistance value R₄ of the second resistor 8B each are 1,000 ohm, the voltage V_{A} of the voltage applying device 31 is 10 voltage, and the volume of the fixed resistor 5 is reduced to the half (the electrical resistance value becomes 2,000 ohm (twice compared to that before the trimming)) by the trimming. Herein, in a case where the second resistor 8B is not provided, the partial voltage applied to the fixed resistor 5 after the trimming is increased by 5/3 voltage compared to the partial voltage before the trimming. On the contrary, in a case where the second resistor 8B is provided, the partial voltage applied to the fixed resistor 5 after the trimming is increased only by 2/3 voltage compared to the partial voltage before the trimming.

In other words, an amount of change in the partial voltage applied to the fixed resistor 5 in a case where the fixed resistor 5 is trimmed by a certain amount is reduced by providing the second resistor 8B. Therefore, it is easy to perform the fine adjustment of the partial voltage of the fixed resistor 5 by the trimming, and it is possible to improve the accuracy of the trimming.

In the pressure detection device 1D of the embodiment, at least one (the partial voltage V_{P1} of the fixed resistor 5 in the embodiment) of the partial voltage V_{P2} of the pressure-sensitive body 4 and the partial voltage V_{P1} of the fixed resistor 5 is measured in a case where a predetermined pressure is applied to the pressure-sensitive body 4 (the first process), and the trimming of the fixed resistor 5 is performed on the basis of the ratio (V_{P2}:V_{P1}) between the partial voltage V_{P2} of the pressure-sensitive body 4 and the partial voltage V_{P1} of the fixed resistor 5 (the second process). Therefore, in the embodiment, it is also possible to reduce the measurement deviation among the products of the pressure detection device 1D without changing the voltage-load characteristic of the pressure-sensitive body 4.

Since the second circuit 92 in the embodiment is configured to electrically connect the second resistor 8B and the fixed resistor 5 in parallel, the partial voltage V_{P1} of the fixed resistor 5 is equal to the partial voltage V_{P1′} of the second circuit 92 (V_{P1}=V_{P1}). Therefore, the partial voltage V_{P1′} of the second circuit 92 is measured (the first process), and the trimming of the fixed resistor 5 may be performed on the basis of the ratio (V_{P2}:V_{P1}) between the partial voltage V_{P2} of the pressure-sensitive body 4 and the partial voltage V_{P1′} of the second circuit 92 in a case where a predetermined pressure is applied to the pressure-sensitive body 4 (the second process).

In the embodiment, the electrical resistance value R₂ of the pressure-sensitive body 4 and a combined resistance (R₁×R₄/(R₁+R₄)) of the second circuit 92 in a case where a predetermined pressure is applied to the pressure-sensitive body 4 are measured in advance (the first process), and the trimming of the fixed resistor 5 may be performed on the basis of the ratio (R₂:(R₁×R₄/(R₁+R₄))) (the second process).

In the embodiment, it is possible to correct the measurement deviation among the product of the pressure detection device 1D without performing the computer process. Therefore, even in a case where the measurement amount of the pressure detection device 1D is increased, it is possible to suppress the occurrence of the response delay caused by the increase of the measurement amount.

### Fifth Embodiment

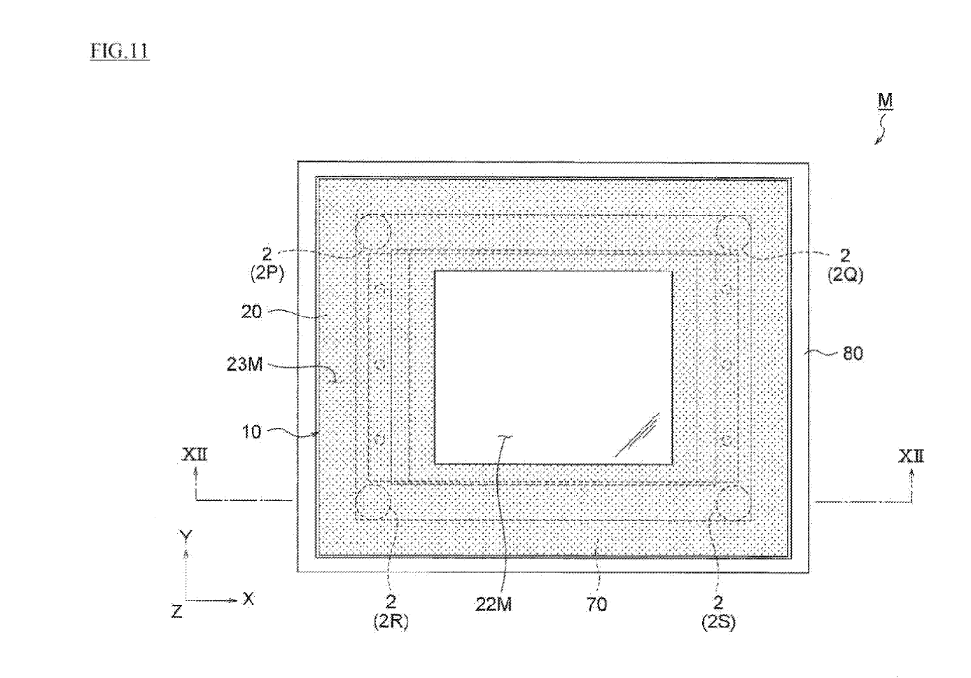

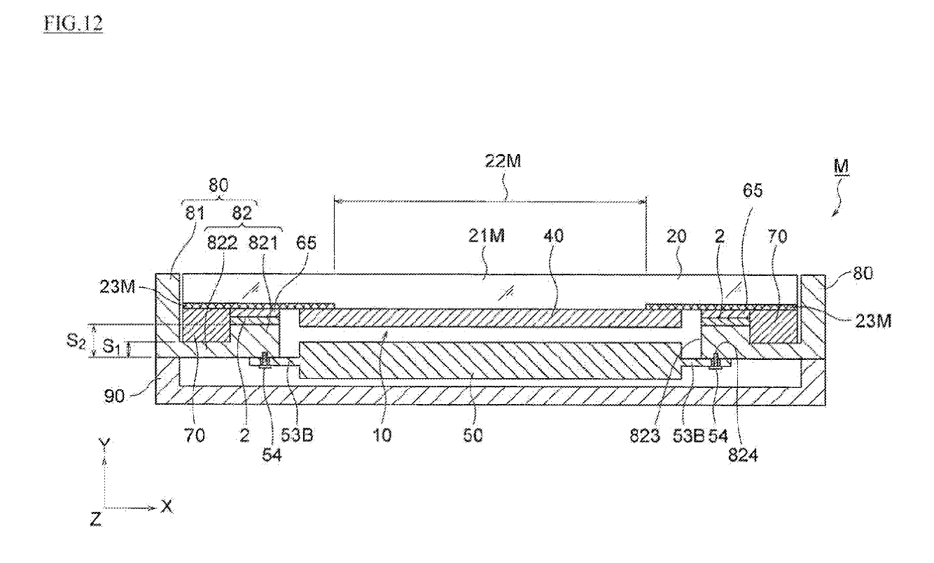

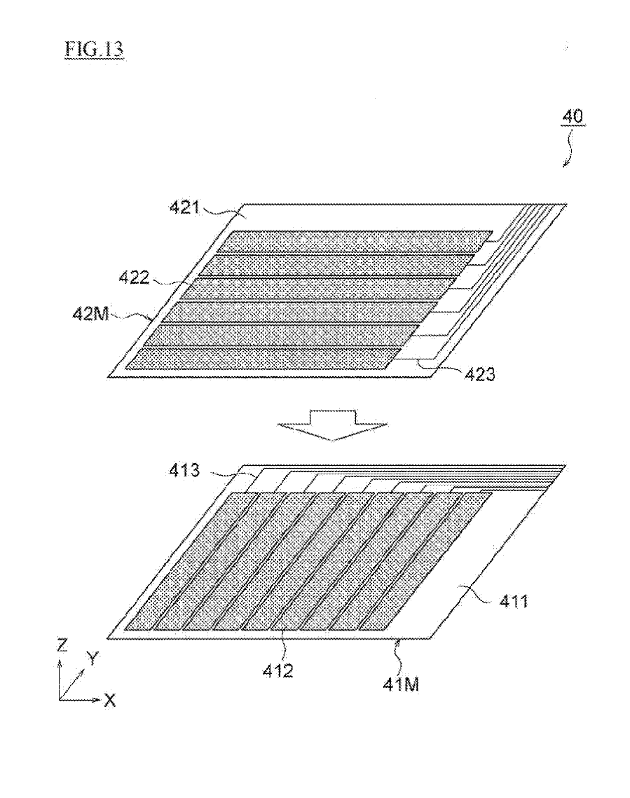

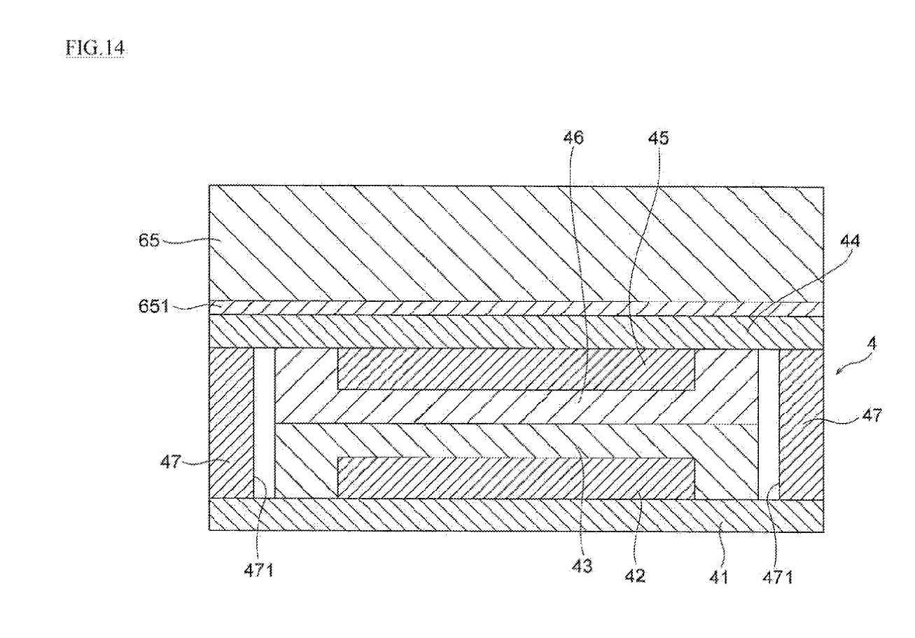

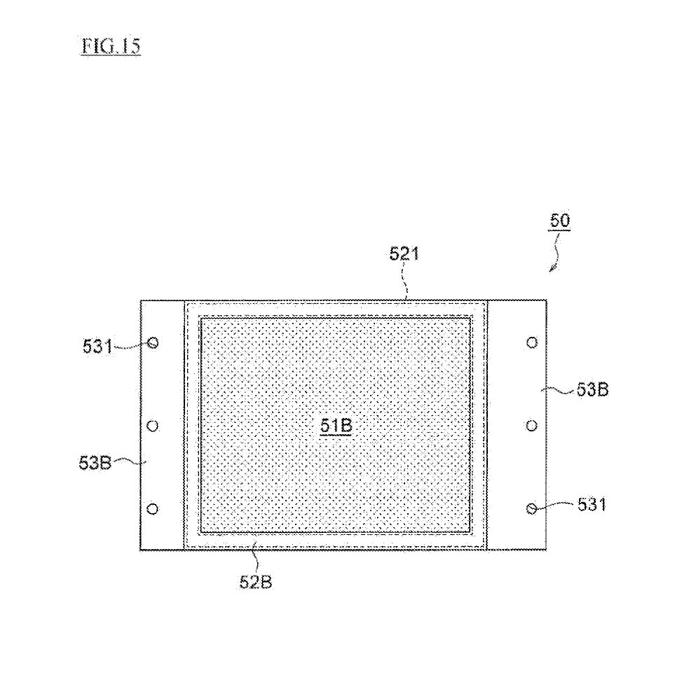

FIGS. 11 and 12 are a plan view and a cross-sectional view illustrating an electronic device in a fifth embodiment, FIG. 13 is an exploded perspective view illustrating a touch panel in the fifth embodiment, FIG. 14 is a cross-sectional view illustrating the pressure-sensitive body and an elastic member in the fifth embodiment, and FIG. 15 is a plan view illustrating a display device in the fifth embodiment. Further, in the following description, the same portions as those of the above-mentioned embodiment will be denoted with the same symbols and the descriptions thereof will not be repeated.

As illustrated in FIGS. 11 and 12, an electronic device M in the fifth embodiment of the invention includes a panel unit 10, a display device 50, the pressure-sensitive sensors 2, a seal member 70, a first support member 80, and a second support member 90. The panel unit 10 includes a cover member 20 and a touch panel 40. The panel unit 10 is supported by the first support member 80 through the pressure-sensitive sensors 2 and the seal member 70, a minute vertical movement of the panel unit 10 with respect to the first support member 80 is allowed by elastic deformation of the pressure-sensitive sensors 2 and the seal member 70. The configuration of the panel unit 10 is not particularly limited to the above description. For example, only the cover member 20 may be configured in the panel unit 10 while eliminating the touch panel 40, or the panel unit 10 may be configured using a touch pad instead of the touch panel 40.

The electronic device M can display an image by the display device 50 (display function). In addition, when an operator designates an arbitrary position on a screen by a finger or a touch pen etc., the electronic device M can detect the XY coordinates by the touch panel 40 (position input function). Furthermore, when the panel unit 10 is pressed in a Z direction by an operator's finger etc., the electronic device M can detect the pressing operation by the pressure-sensitive sensors 2 (pressing detection function).

As illustrated in FIGS. 11 and 12, the cover member 20 is configured by a transparent substrate 21M which can transmit visible light. As a specific example of the material of the transparent substrate 21M, glass, polymethyl methacrylate (PMMA), and polycarbonate (PC) can be exemplified. In a case where the panel unit 10 is configured only by the cover member 20 while eliminating the touch panel 40, or in a case where the panel unit 10 is configured using a touch pad instead of the touch panel 40, the cover member 20 may be an opaque substrate through which the visible light is not transmitted.

In the embodiment, a shielding portion (a bezel portion) 23M is provided on the lower surface of the transparent substrate 21M, and the shielding portion 23M is formed, for example, by coating a white ink or a black ink. The shielding portion 23M is formed in a frame shape on an area of the lower surface of the transparent substrate 21M except a center rectangular transparent portion 22M.

The shapes of the transparent portion 22M and the shielding portion 23M are not particularly formed in the shape described above. The shielding portion 23M may be formed by attaching a white or black decorating member to the lower surface of the transparent substrate 21M. Alternatively, the shielding portion 23M may be formed by preparing a transparent sheet and attaching the transparent sheet to the lower surface of the transparent substrate 21M. The transparent sheet has almost the same size as that of the transparent substrate 21M, and only a portion of the transparent sheet corresponding to the shielding portion 23M is colored with white or black.

As illustrated in FIG. 13, the touch panel 40 is an electrostatic capacitive touch panel which includes two electrode sheets 41M and 42M overlapped with each other.

A configuration of the touch panel 40 is not particularly limited, for example, a touch panel in a resistive film type or a touch panel in an electromagnetic induction type may be employed. A first electrode pattern 412 or a second electrode pattern 422 described below is formed on the lower surface of the cover member 20, and the cover member 20 may be used as a portion of the touch panel. Alternatively, a touch panel in which the electrodes are formed in both surfaces of one sheet instead of the two electrode sheets 41M and 42M may be employed.

A first electrode sheet 41M includes a first transparent substrate 411 through which the visible light is transmitted, and electrode patterns 412 which are provided on the first transparent substrate 411.

Examples of a specific material of the first transparent substrate 411 may include a resin material, such as polyethylene-telephthalate (PET), polyethylene naphthalate (PEN), polyethylene (PE), polypropylene (PP), polystyrene (PS), ethylene-vinyl acetate copolymer resin (EVA), vinyl resin, polycarbonate (PC), polyamide (PA), polyimide (PI), polyvinyl alcohol (PVA), acrylic resin, and triacetylcellulose (TAC), or a glass material.

The first electrode pattern 412 is a transparent electrode, for example, which is configured of an indium tin oxide (ITO) or a conductive polymer, and is formed in a surface pattern (so-called solid pattern) of a strip shape extending along a Y direction in FIG. 13. In the example illustrated in FIG. 13, nine electrode patterns 412 are arranged in parallel to each other on the first transparent substrate 411. The shape, the number, and the arrangement of the first electrode patterns 412 are not particularly limited to the above configuration.

In a case where the first electrode pattern 412 is configured by the ITO, the first electrode pattern is formed by sputtering, photolithography, and etching for example. On the other hand, in a case where the first electrode pattern 412 is configured by a conductive polymer, the first electrode pattern may be formed by the sputtering or the like similarly to the ITO, or may be formed by a printing method such as a screen printing or a gravure printing or by the etching after coating.

Examples of a specific example of the conductive polymer of the first electrode pattern 412 may include an organic compound such as polythiophene, polypyrrole, polyaniline, polyacetylene, and polyphenylene. Among them, a PEDOT/PSS compound is desirably used.

The first electrode pattern 412 may be formed by printing and curing the conductive paste on the first transparent substrate 411. In this case, in order to secure a sufficient optical transparency of the touch panel 40, each first electrode pattern 412 is formed in a mesh shape instead of the surface pattern. As the conductive paste, for example, a composite obtained by mixing metal particles such as silver (Ag) or coper (Cu) with a binder such as polyester or polyphenol can be used.

The first electrode patterns 412 are connected to a touch panel driving circuit (not illustrated) through a first lead-out wiring 413. The first lead-out wiring 413 is provided at a position facing the shielding portion 23M of the cover member 20 on the first transparent substrate 411, so that the first lead-out wiring 413 is not visible from the operator. The first lead-out wiring 413 is formed by printing and curing the conductive paste on the first transparent substrate 411.

Also a second electrode sheet 42M includes a second transparent substrate 421 through which the visible light is transmitted, and second electrode patterns 422 which are provided on the second transparent substrate 421.

The second transparent substrate 421 is configured by the same material as that of the above-mentioned first transparent substrate 411. Similarly to the above-mentioned first electrode pattern 412, also the second electrode pattern 422, for example, is a transparent electrode configured by the indium tin oxide (ITO) or the conductive polymer.

The second electrode pattern 422 is configured by the surface pattern of a strip shape extending along an X direction in FIG. 13. In the example illustrated in FIG. 13, six second electrode patterns 422 are arranged in parallel to each other on the second transparent substrate 421. The shape, the number, and the arrangement of the second electrode wiring patterns 422 are not particularly limited to the above configuration.

The second electrode patterns 422 are connected to the touch panel driving circuit (not illustrated) through a second lead-out wiring pattern 423. The touch panel driving circuit, for example, periodically applies a predetermined voltage between the first electrode pattern 412 and the second electrode pattern 422, and a position of a finger on the touch panel 40 is detected on the basis of a change in electrostatic capacitance at intersections between the first and second electrode patterns 412 and 422.

The second lead-out wiring pattern 423 is provided at a position facing the shielding portion 23M of the cover member 20 on the second transparent substrate 421, so that the second lead-out wiring pattern 423 is not visible from the operator. Therefore, similarly to the above-mentioned first lead-out wiring 413, the second lead-out wiring pattern 423 is also formed by printing and curing the conductive paste on the second transparent substrate 421.

The first electrode sheet 41M and the second electrode sheet 42M are attached to each other through a transparent adhesive such that the first electrode pattern 412 and the second electrode pattern 422 are substantially orthogonal in plan view. The touch panel 40 itself is also attached to the lower surface of the cover member 20 through the transparent adhesive such that the first and second electrode patterns 412 and 422 face the transparent portion 22M of the cover member 20. As a specific example of the transparent adhesive, acrylic adhesive or the like can be exemplified.

As illustrated in FIG. 12, the panel unit 10 configured by the cover member 20 and the touch panel 40 described above is supported by the first support member 80 through the pressure-sensitive sensors 2 and the seal member 70. As illustrated in FIG. 11, the pressure-sensitive sensors 2 are provided at four corners of the panel unit 10. On the contrary, the seal member 70 is disposed on the outside of the pressure-sensitive sensors 2, and the seal member 70 is provided at the entire peripheral along the outer edge of the panel unit 10.

The pressure-sensitive sensors 2 and the seal member 70 are attached to the lower surface of the cover member 20 through an adhesive relatively, and the pressure-sensitive sensors 2 and the seal member 70 are attached to the first support member 80 through the adhesive relatively. The number and the arrangement of the pressure-sensitive sensors 2 are not particularly limited as long as the pressure-sensitive sensor 2 stably holds the panel unit 10.

As illustrated in FIG. 14, an elastic member 65 is provided at the upper portion of the pressure-sensitive body 4 of the pressure-sensitive sensor 2 in the embodiment. The elastic member 65 is stacked on the second substrate 44 through an adhesive 651. The elastic member 65 is configured of a foaming material or an elastic material such as a rubber material. As a specific example of the foaming material of the elastic member 65, urethane foam, polyethylene foam, or silicone foam of a closed-cell type can be exemplified. As the rubber material of the elastic member 65, polyurethane rubber, polystyrene rubber, or silicone rubber can be exemplified.

The elastic member 65 may be stacked below the first substrate 41. Alternatively, the elastic member 65 may be stacked on the second substrate 44 and stacked below the first substrate 41. The elastic member 65 may be eliminated, however, by including the elastic member 65, a load applied to the pressure-sensitive sensor 2 can be uniformly distributed on the entire pressure-sensitive body 4, it is possible to improve the detection accuracy of the pressure-sensitive sensor 2. In a case where the support members 80 and 90 (described below) are deformed or in a case where tolerances of the support members 80 and 90 in the thickness direction are increased, the deformation or tolerances can be absorbed by the elastic member 65. Furthermore, in a case where an excessive pressure or impact is applied to the pressure-sensitive sensor 2, damage or destruction of the pressure-sensitive sensor 2 can be prevented by the elastic member 65.

The electronic device M in the embodiment includes a plurality (“four” in this example) of pressure-sensitive sensors 2 (hereinafter, referred to as pressure-sensitive sensors 2P, 2Q, 2R, and 2S). The respective fixed resistors 5 of the pressure-sensitive sensors 2P, 2Q, 2R, and 2S are trimmed and adjusted so that a resistance ratios (R₂:R₁) of the pressure-sensitive sensors between the electrical resistance value R₂ of the pressure-sensitive body 4 (the combined resistance of the first circuit 91) and the electrical resistance value R₁ of the fixed resistor 5 (the combined resistance of the second circuit 92) are equal to each other by using a voltage applying unit and a partial voltage measuring unit (not illustrated).

Therefore, in a state where a predetermined load F is applied to each of the pressure-sensitive sensors 2P, 2Q, 2R, and 2S, the ratios (R₂:R₁) between the electrical resistance value R₂ of the pressure-sensitive body 4 of each of the pressure-sensitive sensors 2P, 2Q, 2R, and 2S and the electrical resistance value R₁ of the fixed resistor 5 of each of the pressure-sensitive sensors 2P, 2Q, 2R, and 2S are substantially equal to each other.

The expression “substantially equal” means that in a case where the predetermined load F is applied to each of all the pressure-sensitive sensors 2P, 2Q, 2R, and 2S of the electronic device M, the value (the value of each pressure-sensitive sensor) of the ratio (R₂/R₁) between the electrical resistance value R₂ of the pressure-sensitive body 4 (the combined resistance of the first circuit 91) and the electrical resistance value R₁ of the fixed resistor 5 (the combined resistance of the second circuit 92) falls within ±5% of an average value of the ratios (R₂/R₁) of all the pressure-sensitive sensors 2P, 2Q, 2R, and 2S. Even in a case where the number of pressure-sensitive sensors of the electronic device M is “3” or less or “5” or more, the electrical resistance value of the fixed resistor 5 of the pressure-sensitive sensor is similarly adjusted so that the ratios (R₂:R₁) of all the pressure-sensitive sensors between the electrical resistance value R₂ of the pressure-sensitive body 4 and the electrical resistance value R₁ of the fixed resistor 5 are substantially equal to each other.

Similarly to the elastic member 65, the seal member 70 in the embodiment is configured of the foaming material or the elastic material such as the rubber material. As a specific example of the foaming material of the seal member 70, urethane foam, polyethylene foam, or silicone foam of a closed-cell type can be exemplified. As the rubber material of the seal member 70, polyurethane rubber, polystyrene rubber, or silicon rubber can be exemplified. It is possible to prevent foreign matters from entering from the outside by providing the seal member 70 between the cover member 20 and the first support member 80.

As illustrated in FIG. 12, the pressure-sensitive sensors 2 and the seal member 70 described above are interposed between the cover member 20 and the first support member 80. The first support member 80 includes a frame portion 81 and a holding portion 82. The frame portion 81 is formed in a rectangular frame shape having an opening in which the cover member 20 is contained. On the other hand, the holding portion 82 is formed in a rectangular ring shape, and protrudes from the lower end of the frame portion 81 toward the inside in a radical direction.

The first support member 80, for example, is configured of a metal material such as aluminum, or a resin material such as polycarbonate (PC) and an ABS resin. In the embodiment, the frame portion 81 and the holding portion 82 are integrally formed, but may be separately formed.

As illustrated in FIG. 12, the holding portion 82 in the embodiment includes a first area 821 which holds the pressure-sensitive sensors 2 and a second area 822 which holds the seal member 70. The first area 821 is disposed in a circular shape to surround a center opening 823 of the holding portion 82, and the second area 822 is disposed in a circular shape on the outside of the first area 821 in a radical direction.

Only the first area 821 of the holding portion 82 may be formed in a convex shape. In the embodiment, the pressure-sensitive sensor 2 and the seal member 70 are adjacently disposed, but the pressure-sensitive sensor 2 and the seal member 70 may be separately disposed (that is, the first area 821 and the second area 822 may be separately disposed).

A relation between the thickness of the first area 821 and the thickness of the second area 822 is not particularly limited, and as described in the embodiment, it is desirable that the first area 821 be relatively thick compared to the second area 822. In this case, in a space formed between the panel unit 10 and the first support member 80, a space of a first portion S₁ where the pressure-sensitive sensor 2 is provided is relatively narrow compared to a space of a second portion S₂ where the seal member 70 is provided (S₁<S₂). In general, in a case where two elastic bodies having the same elastic modulus are formed different in thickness from each other, a large stress value appears in the narrow elastic body compared to the thick elastic body in the same displacement. Therefore, in the above relation (S₁<S₂) is satisfied, when the panel unit 10 is pressed, a stress generated in the pressure-sensitive sensor 2 per unit displacement can be made relatively larger than a stress generated in the seal member 70 per unit displacement.

As illustrated in FIG. 15, the display device 50 includes a display area 51B which displays an image, and an outer edge area 52B which surrounds the display area 51B, and flanges 53B which protrudes from the both ends of the outer edge area 52B. The display area 51B of the display device 50, for example, is configured of a thin display device such as a liquid crystal display, an organic EL display, or an electronic paper.

The flange 53B is provided with through holes 531, and each of the through holes 531 is disposed to face a screw hole 824 which is formed in the rear surface of the first support member 80 (see FIG. 12). As illustrated in FIG. 12, a screw 54 is engaged with the screw hole 824 through the through hole 531 to fix the display device 50 to the first support member 80. Therefore, the display area 51B is disposed to face the transparent portion 22B of the cover member 20 through the center opening 823 of the first support member 80.

Similarly to the above-mentioned first support member 80, the second support member 90, for example, is configured of a metal material such as aluminum, or a resin material such as polycarbonate (PC) and an ABS resin. The second support member 90 is attached to the first support member 80 through an adhesive to cover the rear surface of the display device 50. Instead of the adhesive, the second support member 90 may be fastened to the first support member 80 through a screw.

As described above, the electronic device M in the embodiment includes a plurality (“four” in this example) of pressure-sensitive sensors 2P, 2Q, 2R, and 2S. In a state where the predetermined load F is applied to each of the pressure-sensitive sensors 2P, 2Q, 2R, and 2S, the ratios (R₂:R₁) between the electrical resistance value R₂ of the pressure-sensitive body 4 and the electrical resistance value R₁ of the fixed resistor 5 are substantially equal to each other. Therefore, it is possible to reduce the measurement deviation among the pressure-sensitive sensors 2P, 2Q, 2R, and 2S without changing the voltage-load characteristic of the pressure-sensitive body 4 of each of the pressure-sensitive sensors 2P, 2Q, 2R, and 2S. Accordingly, it is possible to improve the detection accuracy of the pressure-sensitive sensors 2P, 2Q, 2R, and 2S, and it is possible to suppress the response delay in a case where the measurement amount is increased.

The embodiment described above has been described in order to help with understanding on the invention, and the invention is not limited thereto. Therefore, the respective components disclosed in the above embodiment include all the variations in design and equivalents belonging to the technical scope of the invention.

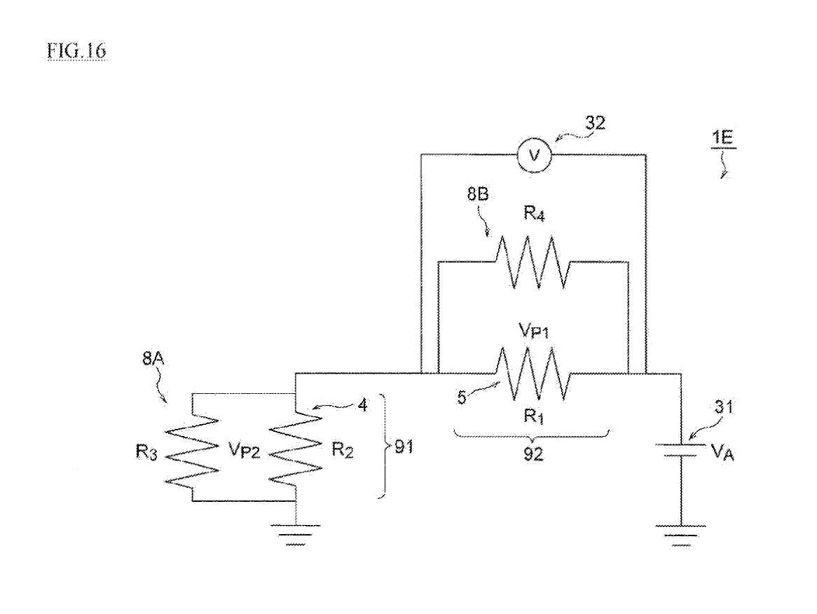

For example, as a pressure detection device 1E illustrated in FIG. 16, the first circuit 91 may include the first resistor 8A described in the third embodiment, and the second circuit 92 may include the second resistor 8B described in the fourth embodiment.

In this case, at least one (the partial voltage V_{P1} of the fixed resistor 5 in this example) of the partial voltage V_{P2′} of the first circuit 91 and the partial voltage V_{P1′} of the second circuit 92 is measured in a case where a predetermined pressure is applied to the pressure-sensitive body 4 (the first process), and the fixed resistor 5 may be trimmed on the basis of the ratio (V_{P2′}:V_{P1′}) between the partial voltage V_{P2′} of the first circuit 91 and the partial voltage V_{P1′} of the second circuit 92 (the second process). The combined resistance (R₂×R₃/(R₂+R₃)) of the first circuit 91 and the combined resistance (R₁×R₄/(R₁+R₄)) of the second circuit 92 in a case where the predetermined pressure is applied to the pressure-sensitive body 4 are measured in advance (the first process), and the fixed resistor 5 may be trimmed on the basis of the ratio ((R₂×R₃/(R₂+R₃)):(R₁×R₄/(R₁+R₄))) (the second process).

In this embodiment, it is possible to absorb the deviation on a low load side in the voltage-load characteristic of the pressure detection device 1E, and it is possible to improve the accuracy in the trimming of the fixed resistor 5. In this embodiment, it is also possible to effectively reduce the measurement deviation among the products of the pressure detection device 1E, and it is possible to suppress the response delay when the measurement amount is increased.

For example, the first and second substrates 41 and 44 of the pressure-sensitive body 4 described in the first embodiment may be formed as the same substrate. In this case, after the first and second electrodes and the first and second pressure-sensitive materials are formed on one substrate, the subject substrate is bent while the spacer is interposed therein, thereby configuring the pressure-sensitive body.

For example, the ratio (R₂:R₁) between the electrical resistance value R₂ of the pressure-sensitive body 4 and the electrical resistance value R₁ of the fixed resistor 5 in a case where a predetermined pressure is applied to the pressure-sensitive body 4 may be adjusted by increasing a volume of the fixed resistor.

For example, the first circuit 91 may include a resistor which is electrically connected to the pressure-sensitive body 4 in series, and the resistor has a predetermined electrical resistance value. The second circuit 92 may include a resistor which is electrically connected to the fixed resistor 5 in series, and the resistor has a predetermined electrical resistance value. In these cases, at least one of the partial voltage of the first circuit 91 and the partial voltage of the second circuit 92 in a case where a predetermined pressure is applied to the pressure-sensitive body 4 is measured (the first process), and the fixed resistor 5 is trimmed on the basis of a ratio between the partial voltage of the first circuit 91 and the partial voltage of the second circuit 92 (the second process), so that it is also possible to reduce the measurement deviation among the products of the pressure detection device without changing the voltage-load characteristic of the pressure-sensitive body 4. If the pressure is actually measured using the pressure detection device, the magnitude of the subject pressure is obtained on the basis of the partial voltage of the first circuit 91 or the partial voltage of the second circuit at the time of applying the pressure to the pressure-sensitive body 4.

### EXPLANATIONS OF LETTERS OF NUMBERS

1, 1B Pressure detection device
2, 2B Pressure-sensitive sensor
   91 First circuit
4, 4B Pressure-sensitive body
41 First substrate
42 First electrode
43 First pressure-sensitive material
44 Second substrate
45 Second electrode
46 Second pressure-sensitive material
47 Spacer
48 Substrate
92 Second circuit
5 Fixed resistor
51 First side portion
52 Second side portion
31 Voltage applying device
32 Voltmeter
601 First wiring pattern
602 Second wiring pattern
603 Third wiring pattern
604 Fourth wiring pattern
61 First connection piece
62 Second connection piece
641 First wiring
642 Second wiring
643 Third wiring
644 Fourth wiring
M Electronic device
10 Panel unit
20 Cover member
22M Transparent portion
40 Touch panel
50 Display device
51B Display area

1. A method for producing a pressure detection device, comprising:
a first process of preparing a pressure-sensitive sensor which includes a first circuit and a second circuit electrically connecting each other in series, the first circuit including a pressure-sensitive body of which an electrical resistance value is consecutively changed according to a pressure, the second circuit including a fixed resistor of which an electrical resistance value can be adjusted to be a desired value; and
a second process of adjusting the electrical resistance value of the fixed resistor on the basis of a ratio between an electrical resistance value of at least pressure-sensitive body in the first circuit and an electrical resistance value of at least fixed resistor in the second circuit in a case where a predetermined pressure is applied to the pressure-sensitive body.

2-12. (canceled)

13. The method for producing the pressure detection device according to claim 1, wherein
the second process includes adjusting a volume of the fixed resistor so as to adjust the electrical resistance value of the fixed resistor.

14. The method for producing the pressure detection device according to claim 1, wherein
the first process includes measuring the electrical resistance value of at least the pressure-sensitive body in the first circuit and the electrical resistance value of at least the fixed resistor in the second circuit.

15. The method for producing the pressure detection device according to claim 1, wherein
the first circuit includes a first resistor which is electrically connected to the pressure-sensitive body in parallel.

16. The method for producing the pressure detection device according to claim 1, wherein
the second circuit includes a second resistor which is electrically connected to the fixed resistor in parallel.

17. The method for producing the pressure detection device according to claim 1, wherein
the pressure-sensitive body includes:
a first substrate on which a first electrode is provided;
a second substrate having a second electrode provided to face the first electrode;
a spacer which is interposed between the first substrate and the second substrate; and
a pressure-sensitive material which is provided to cover at least one surface of the first electrode and the second electrode.

18. A method for producing a pressure detection device, comprising:
a first process of preparing a pressure-sensitive sensor which includes a first circuit and a second circuit electrically connecting each other in series, the first circuit including a pressure-sensitive body of which an electrical resistance value is consecutively changed according to a pressure, the second circuit including a fixed resistor of which an electrical resistance value can be adjusted to be a desired value; and
a second process of adjusting the electrical resistance value of the fixed resistor on the basis of a partial voltage of at least the pressure-sensitive body in the first circuit or a partial voltage of at least the fixed resistor in the second circuit in a case where a predetermined pressure is applied to the pressure-sensitive body and a predetermined voltage is applied to the pressure-sensitive sensor.

19. The method for producing the pressure detection device according to claim 18, wherein
the second process includes adjusting a volume of the fixed resistor so as to adjust the electrical resistance value of the fixed resistor.

20. The method for producing the pressure detection device according to claim 18, wherein
the first process includes
measuring at least one of the partial voltage of at least the pressure-sensitive body in the first circuit and the partial voltage of at least the fixed resistor in the second circuit.

21. The method for producing the pressure detection device according to claim 18, wherein
the first circuit includes a first resistor which is electrically connected to the pressure-sensitive body in parallel.

22. The method for producing the pressure detection device according to claim 18, wherein
the second circuit includes a second resistor which is electrically connected to the fixed resistor in parallel.

23. The method for producing the pressure detection device according to claim 18, wherein
the pressure-sensitive body includes:
a first substrate on which a first electrode is provided;
a second substrate having a second electrode provided to face the first electrode;
a spacer which is interposed between the first substrate and the second substrate; and
a pressure-sensitive material which is provided to cover at least one surface of the first electrode and the second electrode.

24. A pressure detection device comprising:
a pressure-sensitive sensor which includes a first circuit and a second resistor electrically connecting each other, the first circuit including a pressure-sensitive body of which an electrical resistance value is consecutively changed according to a pressure, the second circuit including a fixed resistor;
a voltage applying unit configured to apply a predetermined voltage to the pressure-sensitive sensor; and
a measurement unit configured to measure
at least one of a partial voltage of at least the pressure-sensitive body in the first circuit and a partial voltage of at least the fixed resistor in the second circuit, or
an electrical resistance value of at least the pressure-sensitive body in the first circuit and an electrical resistance value of at least the fixed resistor in the second circuit,
wherein the electrical resistance value of the fixed resistor is capable of being adjusted to adjust a ratio between the electrical resistance value of at least the pressure-sensitive body in the first circuit and the electrical resistance value of at least the fixed resistor in the second circuit in a case where a predetermined pressure is applied to the pressure-sensitive body.

25. The pressure detection device according to claim 24, wherein
the electrical resistance value of the fixed resistor is capable of being adjusted by partially removing the fixed resistor.

26. A pressure-sensitive sensor comprising:
a pressure-sensitive body configured to have an electrical resistance value which is consecutively changed according to a pressure; and
a fixed resistor configured to be capable of being partially removed, wherein the pressure-sensitive body includes:
a first substrate which has a first electrode and a first connection pattern extending from the first electrode;
a second substrate which has a second electrode provided to face the first electrode and a second connection pattern extending from the second electrode;
a spacer which is interposed between the first substrate and the second substrate; and
a pressure-sensitive material which is provided to cover at least one surface of the first electrode and the second electrode,
the first substrate has:
a first connection piece which is branched from the first connection pattern and electrically connected to one end of the fixed resistor;
a second connection piece which is electrically connected to the other end of the fixed resistor; and
a third connection pattern which is electrically connected to the second connection piece, and
the fixed resistor is interposed between the first connection piece and the second connection piece.

27. The pressure-sensitive sensor according to claim 26, wherein
the first substrate and the second substrate are the same substrate which is bent at a bending portion, and
the first substrate further has a fourth connection pattern which is electrically connected to the second connection pattern through the bending portion.

28. An electronic device comprising:
a panel unit; and
pressure-sensitive sensors configured to be deformed according to a pressure through the panel unit, wherein
each of the pressure-sensitive sensors includes a first circuit and a second circuit which electrically connecting each other in series, the first circuit including at least pressure-sensitive body of which an electrical resistance value is consecutively changed according to a pressure, the second circuit including at least fixed resistor,
resistance ratios of the pressure-sensitive sensors are substantially equal to each other, and
the resistance ratio is a ratio between an electrical resistance value of at least the pressure-sensitive body in the first circuit in a case where a predetermined pressure is applied to the pressure-sensitive body and an electrical resistance value of at least the fixed resistor in the second circuit in a case where the predetermined pressure is applied to the pressure-sensitive body.
